(19) United States
(12) Patent Application Publication
(10) Pub. No.: US 2025/0292985 A1
(43) Pub. Date: Sep. 18, 2025

(54) Fuse Holding Provision in Fuse Holder Cover

(71) Applicant: Eaton Intelligent Power Limited, Dublin (IE)

(72) Inventors: Gautam Sharma, Pune (IN); Robert Stephen Douglass, Wildwood, MO (US)

(21) Appl. No.: 18/602,847

(22) Filed: Mar. 12, 2024

(51) Int. Cl. H01H 85/20

(52) U.S. Cl. CPC H01H 85/2045

(57) ABSTRACT

In one embodiment, a cover for a fuse holder assembly that is configured for one or more working fuses connected in an electrical circuitry is provided. The cover includes a cover housing comprising one or more slots configured to house one or more spare fuses, and a mounting mechanism that is coupled to the cover housing. The one or more spare fuses are disconnected from the electrical circuitry. The mounting mechanism is configured to secure the cover housing to the fuse holder assembly.

### TECHNICAL FIELD

This disclosure generally relates to a fuse holder, and more particularly to a fuse holding provision in a fuse holder cover.

### BACKGROUND

Fuses are widely used as overcurrent protection devices to protect electrical components and circuits in electrical power systems from potentially damaging overcurrent conditions. For example, fuses may include fuse elements that are configured to be heated and melted by high current in order to interrupt the current flowing through the fuses. Once blown, the fuses need to be removed and replaced. Replacement of fuses may be time-consuming and troublesome as it typically requires frequent trips to a storage room to retrieve spare fuses. In certain environments, storage space is limited, and storing a bunch of spare fuses may not be ideal. Moreover, when obtaining a replacement fuse, suitable fuse rating must be determined, which requires additional time and introduces another point of possible human error. Improvements are accordingly desired.

### SUMMARY OF PARTICULAR EMBODIMENTS

This disclosure presents a fuse holder cover with a fuse holding provision configured to hold a spare fuse. In particular, the cover according to this disclosure may utilize a housing configured with one or more slots to house one or more spare fuses. The cover may further be coupled to a fuse holder assembly that houses one or more working fuses. The fuse holder cover is configured to enclose the working and spare fuses, which provides protection from the external environments. The fuse holder cover also provides protection to the external environment from the blown fuses. By housing the spare fuse next to the working fuse, the fuses can be more quickly and more conveniently replaced.

In one embodiment, a cover for a fuse holder assembly that is configured for one or more working fuses connected in an electrical circuitry is provided. The cover includes a cover housing having one or more slots configured to house one or more spare fuses, and a mounting mechanism that is coupled to the cover housing. In particular, the one or more spare fuses are disconnected from the electrical circuitry. Moreover, the mounting mechanism is configured to secure the cover housing to the fuse holder assembly.

In particular embodiments, at least a portion of the cover housing is configured with an access point to the one or more slots. In particular embodiments, the access point to the one or more slots is covered by a lid that is connected to a hinge. In particular embodiments, at least a portion of the cover is transparent. In particular embodiments, the cover further includes a panel that separates the one or more spare fuses from the one or more working fuses. In particular embodiments, the cover further includes a retainer feature configured to secure the one or more spare fuses in the one or more slots. In particular embodiments, the mounting mechanism includes a snap-fit feature. In particular embodiments, the cover further includes an open fuse indicator that indicates whether one or more of the working fuses are opened. In particular embodiments, the one or more slots are configured with a dimension to fit a fuse of a particular size or shape.

In one embodiment, a fuse holder assembly includes a main housing configured to house one or more working fuses connected to an electrical circuitry, and a cover for the main housing. The cover includes a cover housing having one or more slots configured to house one or more spare fuses, and a mounting mechanism that is coupled to the cover housing. In particular, the one or more spare fuses are disconnected from the electrical circuitry. Moreover, the mounting mechanism is configured to secure the cover housing to the main housing.

In particular embodiments, a major axis of the cover housing is parallel to a major axis of the main housing. In particular embodiments, the cover housing is positioned in a particular direction relative to the main housing. In particular embodiments, the cover housing is positioned in front of the main housing. In particular embodiments, at least a portion of the cover housing is configured with an access point to the one or more slots. In particular embodiments, the access point to the one or more slots is covered by a lid that is connected to a hinge. In particular embodiments, at least a portion of the cover is transparent. In particular embodiments, the cover further includes a panel that separates the one or more spare fuses from the one or more working fuses. In particular embodiments, the cover further includes a retainer feature configured to secure the one or more spare fuses in the one or more slots. In particular embodiments, the mounting mechanism includes a snap-fit feature. In particular embodiments, the cover further includes an open fuse indicator that indicates whether one or more of the working fuses are opened.

### BRIEF DESCRIPTION OF THE DRAWINGS

Embodiments in accordance with this disclosure will now be described by reference to the accompanying drawings, in which:

FIG. 1 illustrates a perspective view of an embodiment of a fuse holder assembly according to this disclosure;

FIG. 2 illustrates a perspective view of an embodiment of a cover for the fuse holder assembly according to this disclosure;

FIG. 3 illustrates a perspective view of another embodiment of a cover for the fuse holder assembly according to this disclosure, specifically showing insertion of a spare fuse;

FIG. 4 illustrates a perspective view of a further embodiment of a cover for the fuse holder assembly according to this disclosure, specifically showing insertion of a spare fuse; and

FIGS. 5-6 illustrate left and right perspective views of an embodiment of a three-pole fuse holder assembly having the fuse holder assembly according to this disclosure.

### DESCRIPTION OF EXAMPLE EMBODIMENTS

The embodiments disclosed herein present a fuse holder cover configured with a housing structure to house a spare fuse. The cover may be coupled to a fuse holder assembly that houses a working fuse and may also be configured as a safety cover to protect the working fuse from undesired electrical contact. By housing the spare fuse in the cover, the process of replacing the working fuse with the spare fuse is made easier, quicker, and more convenient. For example, when a working fuse is blown, an operator may be able to readily replace the blown fuse with a spare fuse that is housed within the same cover. The operator may only need to open the cover, take out the spare fuse, and replace the blown fuse. This eliminates the need for making a trip to a storage room to retrieve the spare fuses. Moreover, an operator can determine the fuse rating of the spare fuses when the spare fuses are inserted in the housing, that is, before the working fuse opens. This eliminates the need for finding a replacement fuse with the right rating after the working fuse opens, thereby allowing the blown fuse to be replaced efficiently and quickly, which improves operation safety. Also, the cover according to this disclosure may be designed with a simple, modular structure, thereby allowing the cover to be easily retrofitted to be coupled to existing fuse holders.

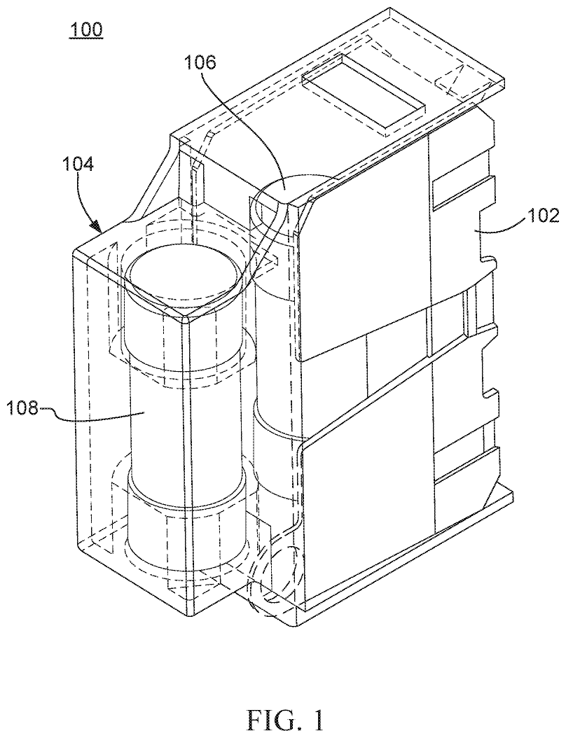

FIG. 1 illustrates an embodiment of a fuse holder assembly 100, with some of the internal components shown in dashed lines. In particular embodiments, the fuse holder assembly 100 may generally include a main housing 102 and a cover 104 for the main housing 102. The main housing 102 may be configured to house and hold one or more working fuses such as a working fuse 106. As an example and not by way of limitation, the working fuse 106 may be connected to an electrical circuitry to provide overcurrent protection. For example, during operation when the current in the circuitry exceeds the rated capacity of the working fuse, a fuse element of the working fuse is configured to heat and eventually melt, breaking the circuitry and stopping the flow of electricity. The breaking of the circuitry from the melting of the fuse element may be described herein as a fuse opening, fuse blowing, fuse tripping, circuit overload, or any other language that conveys breaking of the circuitry. The breaking of the circuitry from the melting of the fuse element prevents damage to the electrical system by preventing high current from reaching the more sensitive circuit components.

A fuse is a one-time-use component, and thus a tripped fuse needs to be removed and replaced with a new fuse to protect the sensitive circuit components. If a fuse opens, a circuitry is typically configured to be left inoperable until the blown fuse is replaced. The longer that it takes to replace the fuse, the longer the circuitry remains inoperable. Traditional methods for replacing the fuse may require frequent trips to the fuse storeroom and may further require identifying the right fuse with the appropriate rating. Such actions are time-consuming. As a solution, in particular embodiments, the cover 104 of the fuse holder assembly 100 may be designed to house one or more spare fuses such as a spare fuse 108 with the correct type and rating. As an example and not by way of limitation, the spare fuse 108 may be separated from working fuse 106 and disconnected from the electrical circuitry. In an embodiment, the spare fuse 108 may be separated from the working fuse with a space. In other embodiments, the spare fuse 108 may be separated from the working fuse with a wall. When overload occurs, the working fuse 106 that is blown may be removed from the main housing 102 (e.g., by opening or removing the cover 104), and the spare fuse 108 may be removed from the cover 104 and installed into the main housing 102 as a working fuse to reestablish electrical connection of the circuitry. This configuration advantageously simplifies the process of fuse replacement and adds the convenience and ease of storing and locating spare fuses. This also reduces system downtime and increases efficiency and utilization. The likelihood of using the wrong type or rating of the spare fuse may also be reduced, thereby ensuring proper circuit operation and enhancing safety.

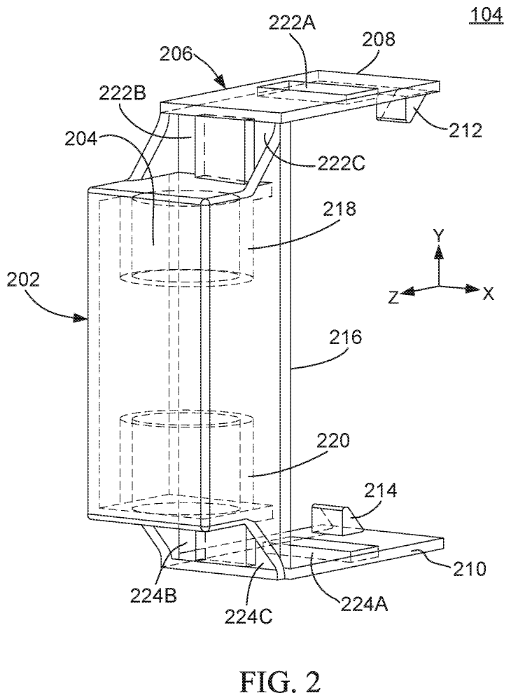

FIG. 2 illustrates an embodiment of the cover 104 for the fuse holder assembly 100, with some of the internal components shown in dashed lines. In particular embodiments, the cover 104 may be removably coupled to the main housing 102 of the fuse holder assembly 100 and may serve as a safety cover to protect the working fuse 106 contained by the main housing 102 from exposure to the external environment and/or provide electric insulation to the working fuse 106. The safety cover may also protect the external environment from the effects of arching or other undesirable effects resulting from a blown fuse. As an example and not by way of limitation, some or the entirety of the cover 104 may be made from electrically insulating materials such as plastic, rubber, fiberglass, silicon, ceramic, glass, or other suitable materials that provide adequate protection from and to the external environment. In particular embodiments, the cover 104 may be separately manufactured and configured to fit onto existing fuse holders to provide the desired fuse holding functionality as needed.

In particular embodiments, the cover 104 may include a cover housing 202 having one or more slots 204 configured to house one or more spare fuses, e.g., spare fuse 108. In the embodiment shown, the cover housing 202 may be configured in a rectangular shape or other suitable shapes such as cylindrical, tubular, etc. When coupled to the main housing 102, a major axis of the cover housing 202 may be parallel to a major axis of the main housing 102 (e.g., along the vertical direction Y). Moreover, the cover housing 202 may be located in front of the main housing 102 (e.g., along the depth direction Z). In some embodiments, the cover housing 202 may be configured to the right or left of, on top of, or below the main housing 102. In the embodiment in which the cover housing 202 is configured in front of the main housing 102 (e.g., FIGS. 1-2), the footprint of the fuse holder assembly 100 may be reduced, which may be useful when the mounting areas have limited space in the vertical direction Y or horizontal direction X.

In particular embodiments, the slot 204 may generally extend along the vertical direction Y of the cover housing 202 and may be configured to provide a space for housing the spare fuse 108. For example, when the cover 104 is mounted to the main housing 102, the slot 204 may be configured at a position substantially parallel to and separated from the main housing 102. As an example and not by way of limitation, the slot 204 may be cylindrical in shape such that the spare fuse 108 may be received inside the slot 204. In some embodiments, the slot 204 may be rectangular or tubular. As further shown, the slot 204 may include an upper wall 218 and a lower wall 220, which may be circular in shape and configured to at least partially or completely surround an upper end and a lower end of the spare fuse 108, respectively, in order to hold the spare fuse 108 in place. In particular embodiments, the slot 204 may be configured with a particular dimension to accommodate various sizes of the spare fuse 108. The slot 204 may also be dimensioned to prevent a fuse with a wrong size (or wrong rating) from being inserted into the slot 204, or dimensioned to fit a fuse with a particular size and/or shape. Additionally or alternatively, one or more locking or retainer mechanisms may be provided in the slot 204 so as to securely hold the spare fuse 108 in place. As an example and not by way of limitation, the retainer mechanisms may have a snap-fit feature such that the spare fuse 108 with the correct fuse size may be snapped in place. Other suitable retainer mechanisms are also contemplated by this disclosure.

In particular embodiments, the spare fuse 108 may be inserted into the slot 204 of the cover housing 202, for example, from the top, bottom, front, back, right, or left of the cover housing 202. In certain embodiments, at least a portion of the cover housing 202 is configured with an access point to the slot 204. For example, the access point to the slot 204 may be covered by a lid that is connected to a hinge. The access point may also not be covered by a lid. As an example and not by way of limitation, a cover housing 202 may be configured with one or more living hinges, allowing a portion of the cover housing 202 (e.g., the lid) to be opened to insert the spare fuse 108 into the slot 204 without removing the cover from the main housing. As another example and not by way of limitation, a cover housing 202 may be configured with one or more windows, allowing easy access to the slot 204 to insert the spare fuse 108 without removing the cover from the main housing. Additionally or alternatively, other suitable features may be provided for allowing the spare fuse 108 to be inserted into the slot 204.

In particular embodiments, the cover 104 may be configured with a mounting mechanism 206 to allow the cover 104 to be mounted to the main housing 102. As an example and not by way of limitation, the mounting mechanism 206 may include an upper leg 208 and a lower leg 210, which may extend from the cover housing 202 along the depth direction Z of the cover housing 202. The upper leg 208 and lower leg 210 may be provided with one or more snap-fit features such as tabs 212, 214 that are used to mount the cover 104 to the main housing 102 without screws, adhesives, or tools. Additionally or alternatively, the cover 104 may be provided with other suitable mounting mechanisms such as protrusions, fasteners, notches, slots, holes, or like, which may be engaged with corresponding mounting mechanisms of the main housing 102. This way, the cover 104 may be removably secured to the main housing 102 to allow for easy removal of the working fuse 106. In particular embodiments, when the cover 104 is coupled to the main housing 102, the upper leg 208 and lower leg 210 may at least partially cover an upper end and a lower end of the main housing 102. The upper and lower legs may be made of the same or different material than the rest of the cover 104 to shield and provide adequate protection for the enclosed fuses from the external environment (or adequate protection to the external environment from opening of the fuse).

In particular embodiments, the cover 104 or at least a portion of the cover 104 may be transparent or translucent such that at least a portion of the spare fuse 108 may be visible from the outside. This way, an individual may easily observe whether there is a spare fuse 108 housed inside the cover 104. It may also allow the user to inspect the fuse type, fuse rating, or other relevant information about the spare fuse 108, which may, for example, be provided on the body of the spare fuse 108 or on the body of the cover 104.

In particular embodiments, the cover 104 may also include a panel 216, which may be configured between the cover housing 202 and the main housing 102. For example, the panel 216 may be configured to separate the spare fuse 108 and the working fuse 106 such that the spare fuse 108 is electrically insulated from the working fuse 106 and/or the electric circuitry connected with the working fuse 106. Therefore, in certain embodiments, the panel 216 may be made from electrically insulating materials such as plastic, rubber, fiberglass, silicon, ceramic, glass, or other electrically insulating material.

In particular embodiments, the cover 104 may be configured with one or more openings to provide ventilation. As an example and not by way of limitation, when the cover 104 is coupled to the main housing 102, the openings may provide air passageways to the interior of the main housing 102 for venting heat from the main housing 102, e.g., via convective airflow. For example, in the embodiment shown, the three openings 222A, 222B, and 222C at the upper portion of the cover 104 (e.g., one in the upper leg 208 and the other two in the panel 216) may serve as outlet vents to allow hot air generated by the working fuse 106 to be released from the main housing 102, while the three openings 224A, 224B, and 224C at the lower portion of the cover 104 (e.g., one in the lower leg 210 and the other two in the panel 216) may be inlet vents to allow ambient air to flow into the main housing 102 for cooling down the working fuse 106. Although three openings are shown at the top and also at the bottom, different numbers, different sizes, and different locations of the openings are also contemplated by this disclosure. For example, the openings may be much smaller and be comprised of perforated holes that are configured at the top and bottom of the cover 104 or throughout the entirety of the cover 104. As another example, the openings may be thin slots that run along the X axis of the cover 104.

In particular embodiments, the cover 104 may be configured with an open fuse indicator (not shown) that indicates whether the working fuse 106 is opened or not. As an example and not by way of limitation, the open fuse indicator may include a circuit having a resistor or other suitable electronic devices configured to sense the voltage or resistance across the working fuse 106 and a lighting element such as an LED, neon bulb, or the like connected to the resistor. For example, when the working fuse 106 blows, the voltage across the working fuse 106 may drop, powering up the lighting element to indicate that the fuse has opened. In particular embodiments, the open fuse indicator may be integrated into the cover 104 on a place that is easily viewed by an individual, for example, on the face of the cover 104 or the top or bottom of the cover 104.

Although this disclosure describes a cover with a particular fuse holding provision in a particular manner, this disclosure contemplates covers with any suitable fuse holding provisions in any suitable manner. For example, each of the various features or aspects of this disclosure may be used separately in some instances, or in combination with other features or aspects of this disclosure in other instances. In addition, various features and aspects of this disclosure may be omitted without departing from the scope of this disclosure.

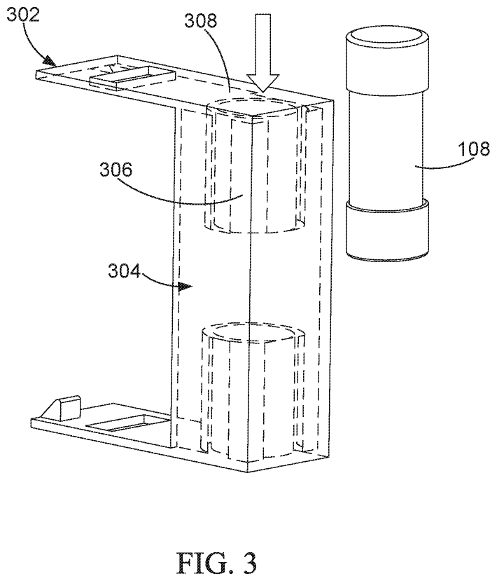

FIG. 3 illustrates another embodiment of a cover 302 for a fuse holder assembly, with some of the internal components shown with dashed lines. The cover 302 incorporates the features described and is compatible with the other embodiments of the covers described above with reference to FIGS. 1-2. For example, the cover 302 may include a housing 304 having one or more slots 306 configured to house one or more spare fuses such as the spare fuse 108. Specifically, in the embodiment shown, the spare fuse 108 may be inserted from the top of the housing 304 into the slot 306 via an access point to the slot 306. When inserted, the spare fuse 108 may be covered fully by the housing 304. As an example and not by way of limitation, a lid or cap 308 may be configured at the upper end of the housing 304 and may be opened to provide access to the slot 306 inside the housing 304. For example, the cap 308 may be coupled to the upper end of the housing 304 via a hinge, a living hinge, or other suitable coupling features.

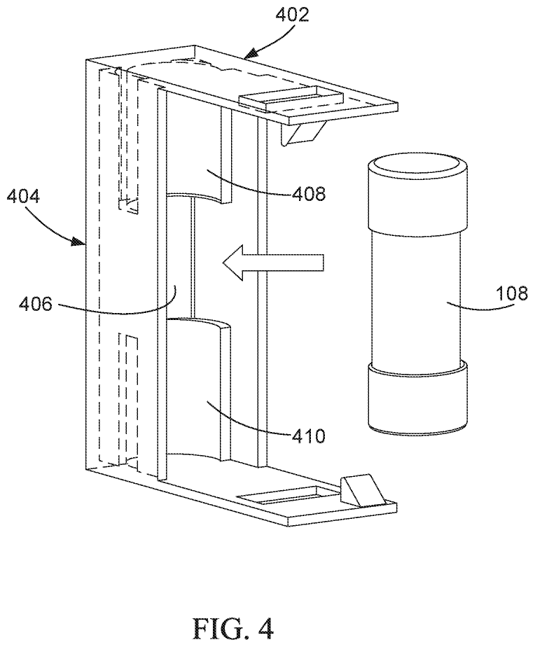

FIG. 4 illustrates a further embodiment of a cover 402 for a fuse holder assembly according to this disclosure, with some of the internal components shown with dashed lines. The cover 402 incorporates the features described and is compatible with the other embodiments of the covers described above with reference to FIGS. 1-3. For example, the cover 402 may include a housing 404 having one or more slots 406 configured to house one or more spare fuses such as a spare fuse 108. Specifically, in the embodiment shown, the spare fuse 108 may be inserted from the back of the housing 404. As an example and not by way of limitation, the back end of the housing 404, which is located proximately to the working fuse 106, may be opened to allow the spare fuse 108 to be inserted into the slot 406. When inserted, the spare fuse 108 may be partially exposed yet separated from the working fuse 106 by a distance to avoid any undesired electrical contact. Additionally, in particular embodiments, an upper retainer feature 408 and a lower retainer feature 410 may be provided in the slot 406, which may be configured to hold the spare fuse 108 in place. As an example and not by way of limitation, the upper retainer feature 408 and the lower retainer feature 410 may be semi-circular, or partially-circular, walls, which may partially surround an upper end and a lower end of the spare fuse 108, respectively.

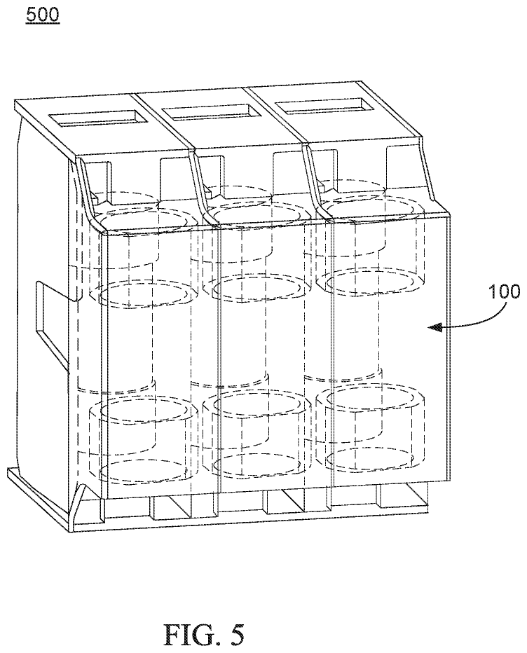

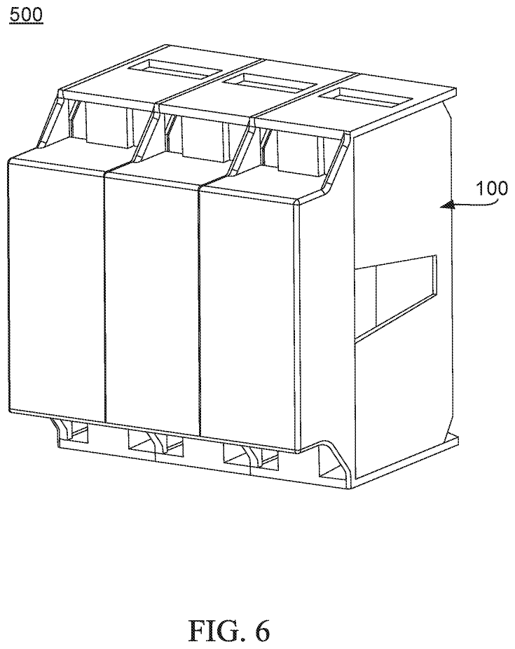

FIGS. 5-6 illustrate respective left and right views of an embodiment of a three-pole fuse holder assembly 500, which may be used to hold and secure three working fuses and three spare fuses. For example, in a three-phase electrical system, the three-pole fuse holder assembly 500 may accommodate one working fuse for each of the three phases to provide individual circuit protection for each phase. In particular embodiments, the three-pole fuse holder assembly 500 may be assembled by coupling three fuse holder assemblies 100 as described above with reference to FIG. 1 together in a parallel grouping. Alternatively, in particular embodiments, the three-pole fuse holder assembly 500 may be assembled by integrating three fuse holder assemblies 100 as a singular system. In particular embodiments, a multi-pole fuse holder assembly may be provided, which may include any suitable number of fuse holder assembly 100. This may be especially useful in electrical circuits where multiple fuses are required to protect different parts of the circuit. The three-pole fuse holder assembly 500 incorporates the features described and is compatible with the other embodiments of the covers described above with reference to FIGS. 1-4. Specifically, FIG. 5 shows the three-pole fuse holder assembly 500 from the right, with some of the internal components shown with dashed lines. FIG. 6 illustrates the three-pole fuse holder assembly 500 from the left, with some of the internal components such as the slots inside the covers hidden from view. In the illustrated embodiment, the three-pole fuse holder assembly 500 may be provided with three separate covers, each of which may be configured to cover one working fuse and house one spare fuse. In other embodiments, a number of the covers may be assembled or integrated together as a single piece, which may include multiple slots to house multiple spare fuses next to the working fuses as needed.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A cover for a fuse holder assembly that is configured for one or more working fuses connected in an electrical circuitry, the cover comprising:
a cover housing comprising one or more slots configured to house one or more spare fuses, wherein the one or more spare fuses are disconnected from the electrical circuitry; and
a mounting mechanism that is coupled to the cover housing, wherein the mounting mechanism is configured to secure the cover housing to the fuse holder assembly.

2. The cover of claim 1, wherein at least a portion of the cover housing is configured with an access point to the one or more slots.

3. The cover of claim 2, wherein the access point to the one or more slots is covered by a lid that is connected to a hinge.

4. The cover of claim 1, wherein at least a portion of the cover is transparent.

5. The cover of claim 1, further comprising a panel that separates the one or more spare fuses from the one or more working fuses.

6. The cover of claim 1, further comprising a retainer mechanism configured to secure the one or more spare fuses in the one or more slots.

7. The cover of claim 1, wherein the mounting mechanism comprises a snap-fit feature.

8. The cover of claim 1, further comprising an open fuse indicator that indicates whether one or more of the working fuses are opened.

9. The cover of claim 1, wherein the one or more slots are configured with a dimension to fit a fuse of a particular size or shape.

10. A fuse holder assembly, comprising:
a main housing configured to house one or more working fuses connected in an electrical circuitry; and
a cover for the main housing, the cover comprising:
a cover housing comprising one or more slots configured to house one or more spare fuses, wherein the one or more spare fuses are disconnected from the electrical circuitry; and
a mounting mechanism that is coupled to the cover housing, wherein the mounting mechanism is configured to secure the cover housing to the main housing.

11. The fuse holder assembly of claim 10, wherein a major axis of the cover housing is parallel to a major axis of the main housing.

12. The fuse holder assembly of claim 10, wherein the cover housing is positioned in a particular direction relative to the main housing.

13. The fuse holder assembly of claim 12, wherein the cover housing is positioned in front of the main housing.

14. The fuse holder assembly of claim 10, wherein at least a portion of the cover housing is configured with an access point to the one or more slots.

15. The fuse holder assembly of claim 12, wherein the access point to the one or more slots is covered by a lid that is connected to a hinge.

16. The fuse holder assembly of claim 10, wherein at least a portion of the cover is transparent.

17. The fuse holder assembly of claim 10, wherein the cover further comprises a panel that separates the one or more spare fuses from the one or more working fuses.

18. The fuse holder assembly of claim 10, wherein the cover further comprises a retainer mechanism configured to secure the one or more spare fuses in the one or more slots.

19. The fuse holder assembly of claim 10, wherein the mounting mechanism comprises a snap-fit feature.

20. The fuse holder assembly of claim 10, wherein the cover further comprises an open fuse indicator that indicates whether one or more of the working fuses are opened.
